(19) United States
(12) Patent Application Publication
(10) Pub. No.: US 2024/0209723 A1
(43) Pub. Date: Jun. 27, 2024

(54) APPARATUS AND METHODS FOR USING COLLOIDAL PARTICLES TO CHARACTERIZE FRACTURING TREATMENTS

(71) Applicant: PERM INC., Calgary (CA)

(72) Inventors: Sepideh MAAREF, Calgary (CA); Steven L. BRYANT, Calgary (CA); Apostolos KANTZAS, Calgary (CA)

(21) Appl. No.: 18/392,508

(22) Filed: Dec. 21, 2023

Related U.S. Application Data
(60) Provisional application No. 63/434,633, filed on Dec. 22, 2022.

(51) Int. Cl. E21B 43/267; E21B 47/003

(52) U.S. Cl. CPC E21B 43/267; E21B 47/003

(57) ABSTRACT

Apparatus and methods for determining the size of an underground fracture network. The method includes injecting a colloid into the formation, the colloid including a carrier liquid and sized particles with a particular size distribution. After extracting fluid from the formation, a quantity of the extracted sized particles is determined. Based on the size distribution of the injected sized particles and the measured quantity of extracted sized particles, the size of the fracture network is determined. Using sized particles means that the fractured network can be selectively determined as the particles are too large to enter the rock matrix itself.

### RELATED APPLICATIONS

The invention is a Non-Provisional of, and claims 35 U.S.C. 119 priority to U.S. Provisional Application No. 63/434,633 filed on Dec. 22, 2022 and entitled “Apparatus and Methods for using Colloidal Particles to Characterize Fracturing Treatments” which is hereby incorporated by reference in its entirety.

### BACKGROUND

The invention relates to apparatus and methods for characterizing induced networks of fractures within subsurface formations and, in particular, to using of engineered colloidal particles with a particular size distribution to characterize fracturing treatments.

Characterization of hydraulically induced networks of fractures is one of the main challenges in unconventional oil and gas development. With fractures starting from the wellbore and growing to lengths of hundreds of meters, and with secondary fractures initiating from larger primary fractures, all occurring several km below the earth surface, understanding fracture geometry, distribution, and production response is not straightforward.

Modern practice of multistage fracturing creates multiple sets of fracture networks, one set per “stage” of stimulation, in a single horizontal well, and several wells will be drilled and stimulated in the same fashion in the vicinity of each other. Induced fracture networks may intercept or interact with previously established fracture networks, with deleterious consequences for well production. As a result, field experience suggests that hydraulic fracturing is more complex and unpredictable than initially thought. In some cases, conflicting production performance has been reported for identical treatments within the same formation.

An induced fracture network is a tree-like set of connected cracks in a rock matrix emanating from a wellbore. The cracks have varying apertures. The widest cracks typically start at the wellbore and may extend hundreds of feet from the wellbore. Several narrower cracks can be initiated from the widest crack and extend into the matrix. These may spawn more, even narrower cracks that also extend into the reservoir matrix. The ensemble of these cracks gives rise to the term “stimulated rock volume” or SRV. The SRV represents the total volume of reservoir rock that has been hydraulically fractured. The rate at which fluids flow from the matrix through these cracks into the wellbore depends very strongly on the aperture of the cracks.

Chemical tracers have been used in oil and gas reservoirs and groundwater aquifers for several decades. In conventional reservoirs, the main purpose of a tracer test is for reservoir characterization, including identification of fluid movement, layering, flow barriers, and saturation. During the past decade, chemical tracer usage for fractures diagnostic in unconventional reservoirs has dramatically increased.

A new addition to tracer technology comes by adsorbing chemical tracers onto a solid carrier. Solid tracer carriers have the benefit of being placed with the proppant in the fracture network, however, the specific mass of tracer absorbed onto each carrier bead and the release rate of tracer from the solid carrier in the reservoir is difficult to quantify. Solid tracers also degrade during the frac and do not have the crush strength of sand or manufactured proppant. Tracers can also come in polymer strip form, wherein the tracer can be attached to completion hardware such as sand control screens. This allows for the release of tracer upon contact with water or hydrocarbon at the production interval.

Typical deliverables from a chemical tracer test include analysis regarding frac fluid recovery, wellbore cleanup, stage inf low contribution, fracture geometry, and fracture network complexity. Studies using chemical tracers to evaluate frac fluid distribution within a single fracture stage are limited. Because chemical tracers are of molecular dimensions, they provide no useful information on the apertures of the effective fracture network.

### SUMMARY

In accordance with the invention, there is provided a method for determining an effective size distribution of a productive fracture network within an underground formation, the method comprising:
injecting a colloid into the formation, the colloid comprising a carrier liquid and sized particles with a particular size distribution;
extracting a fluid from the formation, the fluid comprising at least a portion of the injected sized particles;
measuring a quantity of the extracted sized particles; and
determining the effective size distribution of the productive fracture network based on the size distribution of the injected sized particles and the measured quantity of extracted sized particles.

The method may comprise generating the fracture network by fracking.

The fracking may comprise injecting a frac fluid into the formation via a wellbore.

The frac fluid may comprise a proppant.

The colloid may comprise (or be) the frac fluid.

The fracking may comprise multiple frac stages, each frac stage corresponding to a volume of the frac fluid being injected into a different spatial region of the formation, wherein the sized particles in each frac volume associated with each stage are identifiably different.

The sized particles may be formed of a different material for each frac stage.

Measuring the quantity of the extracted sized particles may comprise determining a size distribution of the extracted sized particles.

Measuring the quantity of the extracted sized particles may comprise determining the amount of material making up the particles.

The sized particles may have maximum dimension of between 10 nm and 1 micron. The maximum dimension of a particle may be considered to be the greatest straight-line distance through a particle between the edges of the particle. The sized particles may have a maximum dimension of at least 20 nm. The sized particles may have a maximum dimension of at least 100 nm. The sized particles may have a maximum dimension of at most 1 micron. Because the particle sizes are small, the colloid may behave largely as a liquid in large containers or pipes. The colloid may behave differently in situations where the colloid interacts with gaps which are commensurate in size with the size of the particles. E.g., when the colloid is passing through micron or sub-micron gaps, the sized particles may get trapped.

The sized particles may be solid. The sized particles may be rigid.

The sized particles may comprise one or more of: barium titanate, iron oxide, Fe₂O₃, Fe₃O₄ (magnetite), SiO₂, TiO₂, silica, and zinc oxide.

The sized particles may be insoluble in water and hydrocarbons.

The sized particles may be insoluble in hydrochloric acid (e.g., 15 wt. % and/or 28 wt. %). This may allow the sized particles to be used in conjunction with an acid fracturing treatment.

Acid fracturing may use hydrochloric acid (HCl) 15 wt. %. To obtain more acid penetration and more etching, 28 wt. % HCl is sometimes used as the primary acid fluid. In other embodiments, formic acid (HCOOH) or acetic acid (CH₃COOH) may be used because these acids are easier to inhibit under high-temperature conditions.

Wells may be vertical or horizontal wells.

The sized particles may be generally spherical. At least 90% of the sized particles by number may have a sphericity of at least 0.8. The sphericity of a particle is the ratio of the surface area of a sphere with the same volume as the given particle to the surface area of the particle. At least 90% of the sized particles by number may have equivalent spherical diameter of at least 0.8 times the maximum diameter of the sized particle.

The method may comprise measuring a quantity of the extracted fluid.

The method may comprise determining the quantity of a particular ion or salt in the extracted fluid.

The method may comprise determining a quantity of formation fluid produced from the formation.

The method may comprise determining a quantity of carrier liquid (e.g., injected carrier liquid) recovered from the formation during the extraction of the fluid from the formation.

The carrier liquid may comprise water. The carrier liquid may comprise hydrocarbons. The sized particles may be insoluble in the carrier liquid.

The method may comprise determining a measure of the size of the fracture network based the measured quantity of the recovered carrier liquid.

According to a further aspect, there is provided an apparatus for determining an effective size distribution of a productive fracture network, the apparatus comprising:
a wellbore positioned within a formation;
a colloid source, the colloid comprising a carrier liquid and sized particles of a known size distribution;
a pump for injecting the colloid into the formation via the wellbore;
a container for containing fluids extracted from the wellbore;
an analyser for measuring a quantity of the extracted sized particles; and
a controller for determining the effective size distribution of the productive fracture network based on the size of the injected sized particles and the measured quantity of extracted sized particles.

According to a further aspect, there is disclosed the use of nanoparticles with a predetermined size distribution in determining the fluid conductivity or size of the fracture network.

Using sized particles means that the fractured network can be selectively determined as the particles are too large to enter into the rock matrix itself.

A size distribution may include information on the relative number of particles as a function of size. The size may be a parameter such as diameter, greatest dimension (i.e., maximum length), volume, equivalent mesh or sieve size etc. A size distribution may include information on the absolute number of particles within the colloid (e.g., provided as a raw number or a concentration). A size distribution may comprise information on the volume of carrier fluid/liquid. A size distribution may comprise or consist of information on the minimum and/or maximum sizes of the sized particles.

The quantities measured may be time dependent. For example, the quantity of the extracted sized particles and/or quantity of the extracted fluid/liquid may be measured as a function of time.

The ion or salt concentration measured in the extracted fluid may correspond to a conservative salt or ion. A conservative salt or ion is one which does not typically take part in in water and/or mineral reactions.

The sized particles may have a uniform size. That is, the size distribution corresponds to all the particles having the same size. The sized particles may have a narrow size distribution (e.g., where the maximum dimension of the largest particle is less than twice that of the smallest particle). The sized particles may have a wide size distribution (e.g., where the maximum dimension of the largest particle is at least five times that of the smallest particle).

The sized particles may have a size distribution in which the number of particles per unit volume of carrier fluid is inversely correlated with the diameter of the particles. That is, there may be more smaller particles per unit volume than larger particles. This may help provide more accurate information on the fracture network because the fracture volume accessible to smaller particles will typically be larger than that accessible to larger particles.

Acid fracturing may use hydrochloric acid (HCl) 15 wt. %. To obtain more acid penetration and more etching, 28 wt. % HCl is sometimes used as the primary acid fluid. In other embodiments, formic acid (HCOOH) or acetic acid (CH₃COOH) may be used because these acids are typically easier to inhibit under high-temperature conditions.

A colloid may be considered to be a homogeneous non-crystalline substance consisting of particles of one substance dispersed through a second substance. Colloids include gels, sols, and emulsions. Generally, the particles do not settle, and cannot be separated out by ordinary filtering or centrifuging like those in a suspension. In the context of this technology, the colloid may be configured (e.g., by adjusting the viscosity and density of the carrier liquid and/or the size, shape and/or density of the sized particles) such that the settling rate of the largest sized particles is less than 1 mm/s. This ensures that the sized particles would not settle significantly throughout the duration of the operation. It will be appreciated that the colloid may be mixed before injection, and injection would inherently agitate the colloid.

The sized particles may be nanoparticles or nanodroplets. The sized particles may have a maximum dimension of between 10 nanometers to 1 micrometer. The sized particles may have a maximum dimension of at least 100 nm. 90% of the sized particles by number may be within the size ranges provided. 90% of the sized particles by mass may be within the size ranges provided. The sized particles may be spherical or spheroidal in shape. The Dv90 of the sized particles may be less than 1 micrometer, where D is the maximum dimension.

The size of the sized particles (e.g., injected and/or recovered) may be measured using the technique of Dynamic Light Scattering (DLS). DLS measures and analyses temporal fluctuations in, for example, the intensity or photon auto-correlation function (also known as photon correlation spectroscopy or quasi-elastic light scattering).

The sized particles size may have a range between 20 nm to 1 micrometer, or between 100 nm to 1 micrometer (e.g., as measured by DLS). DLS provides three size distributions in terms of the intensity, volume/mass and number. The D10 refers to the size for first 10% intensity while the D90 is the size for 90% intensity. And D50 is usually termed as median droplet size.

The nanodroplets may be spherical or spheroidal in shape. The Dv90 (in terms of volume) of the colloid may be less than 1 micrometer. The Dv50 of the colloid may be less than 500 nm. The Dv10 of the colloid may be more than 10 nm. D may be the hydrodynamic diameter of the dispersed sized particles.

The size of the nanodroplets (e.g., injected and/or extracted) may be measured using DLS method. DLS measures and analyses temporal fluctuations in, for example, the intensity or photon auto-correlation function (also known as photon correlation spectroscopy or quasi-elastic light scattering).

The matrix may be considered to be the finer grained, interstitial particles that lie between larger particles or in which larger particles are embedded in sedimentary rocks of the formation such as sandstones and conglomerates.

Pore-throat sizes (diameters) are generally greater than 2 μm in conventional reservoir rocks, range from about 2 to 0.03 μm in tight-gas sandstones, and range from 0.1 to 0.005 μm in shales. This technique may be particularly applicable for determining fracture size distribution during hydraulic fracturing in tight or shale reservoirs. The sized particles may have a maximum dimension greater than the pore-throat size of the reservoir rock to prevent the sized particles from entering the rock matrix.

Typical proppant sizes are generally between 8 and 140 mesh (106 μm-2.36 mm), for example 16-30 mesh (600 μm-1180 μm), 20-40 mesh (420 μm-840 μm), 30-50 mesh (300 μm-600 μm), 40-70 mesh (212 μm-420 μm) or 70-140 mesh (106 μm-212 μm). For example, the proppant may be sized using two meshes so that the proppant added is small enough to pass through a first coarser mesh (e.g., 20 mesh) but too big to pass through a second finer mesh (e.g., 70 mesh). This gives an upper and lower bound on the size distribution of the proppant.

The nanoparticles may have a size smaller than the lower bound on the size distribution of the proppant. For example, the largest nanoparticles may be 1 micron (e.g., largest dimension), whereas the smallest proppant particles may be at least 100 microns. This allows the nanoparticles to be separated from the proppant using a mesh with holes no larger than the second finer mesh, but larger than the largest nanoparticle sizes. The nanoparticles may be nanodroplets.

In the context of this disclosure, the effective size distribution of a fracture network may be considered to be the connected volume of a fracture network which is directly connected to the wellbore via channels of greater than a particular lateral dimension. For example, the lateral dimension may be a dimension, d, that means that a sphere of diameter, d, could pass from anywhere within the connected volume to the wellbore. The effective size distribution may also provide information on how the volume of the fracture network changes for different diameters. For example, the same fracture network may have a larger connected volume for a smaller lateral dimension, d. Or the fluid conductivity may provide information on the connected volume within a lateral dimension range (e.g., 10 nm<d<25 nm).

In the context of this disclosure, a formation may be considered to be a rock formation or a geological formation. A formation is a volume or body of rock which shows a consistent and homogeneous set of lithologies that allow to distinguish it from the neighboring sedimentary rocks and that can be mapped in geological maps. The thickness of formations may range from less than a meter to several thousand meters. A frac network may be within one formation or span across multiple formations.

In the context of this disclosure, a fluid is a substance that can flow. A fluid typically comprises a liquid and/or a gas. A fluid may include particles or grains within a carrier liquid.

Fracking pressures may be between 4,500 psi (30,000 kPa) and 9,000 psi (60,000 kPa) or more.

Brine may contain at least 600 mM of salt.

Formation fluid may be considered to be fluid extracted from the formation which was not injected into the formation. Recovered fluid may be considered to be fluid recovered from the formation after first being injected into the formation from the surface.

The analyser may comprise a Dynamic Light Scattering (DLS) analyser. The analyser may comprise a coulter counter.

The analyser may comprise a processor and memory. The memory may store computer program code. The processor may comprise, for example, a central processing unit, a microprocessor, an application-specific integrated circuit or ASIC or a multicore processor. The memory may comprise, for example, flash memory, a hard-drive, volatile memory. The computer program may be stored on a non-transitory medium such as a CD. The computer program may be configured, when run on a computer, to implement methods and processes disclosed herein.

Stimulated rock volume may be considered to represent the total volume of reservoir rock that has been hydraulically fractured.

The fluid conductivity of the fracture network may be considered to be a measure of the property of a particular propped fracture to convey the produced fluids of the well and is measured in terms of proppant permeability and average propped fracture width (md-ft). The fluid conductivity may correspond to the effective size of the network.

The effective size of a productive fracture network may comprise the effective volume of the productive fracture network. The effective size of a productive fracture network may comprise information on the size distribution of the fractures making up the fracture network. The effective size of the productive fracture network may correspond to the size (e.g., volume) of the fracture network which allows the sized particles to be injected into the fractures and recovered. The effective size distribution of a fracture network may be considered to be the connected volume of a fracture network which is directly connected to the wellbore via channels of greater than a particular lateral dimension.

The effective size of a productive fracture network may comprise the stimulated rock volume.

Effective volume of the productive fracture network may be considered to be the effective volume of a propped fracture that contributes to fluid flow after fracture closure happens.

A productive fracture network is a network of fractures through which fluid can be extracted (or produced) from the formation via the well bore.

A particle size distribution indicates the percentage of particles of a certain size (or in a certain size interval).

Inductively Coupled Plasma, or ICP analysis, is a chemical analysis method which can be used to identify both trace amounts and major concentrations of nearly all elements within a sample. ICP analysis may include ICP Mass Spectrometry (ICP-MS) and/or ICP Atomic or Optical Emission Spectroscopy (ICP-AES/ICP-OES).

### BRIEF DESCRIPTION OF THE DRAWINGS

Various objects, features and advantages of the invention will be apparent from the following description of particular embodiments of the invention, as illustrated in the accompanying drawings. The drawings are not necessarily to scale, emphasis instead being placed upon illustrating the principles of various embodiments of the invention. Similar reference numerals indicate similar components.

FIG. 1a is a schematic view of a frac assembly.

FIGS. 1b-d are schematic cross-section of a series of frac steps.

FIG. 1e is a schematic cross-section of the subsurface formation as it undergoes multiple frac stages.

FIG. 2a is a schematic of experimental apparatus for replicating core flooding.

FIG. 2b is a cross sectional view of the core holder.

FIG. 2c is a perspective view of the core.

FIG. 3a is a graph of the concentration of NPs tracer (Ti) during flowback from a field trial.

FIG. 3b is a graph of the concentration of Sodium (Na) ion during flowback from the field trial.

FIG. 3c is a graph of the ratio of injected Sodium ion over the flowback Sodium ion from the field trial.

FIG. 3d is a graph of the injected and produced mass of nanoparticle tracer during flowback from the field trial.

FIG. 4 is a flow diagram showing steps of an embodiment of the process for determining the effective size of the fracture network described herein.

### DETAILED DESCRIPTION

### Introduction

The present technology describes the application of engineered colloids, comprising particles with a known size distribution, as tracers in hydraulic fracturing treatments. Hydraulic fracturing enables production from low permeability and/or organic rich shale-oil/gas reservoirs by stimulating the rock to increase its effective permeability. The stimulation creates a branching network of fractures of varying apertures, lengths and heights. The volumetric extent of this network corresponds to the stimulated reservoir volume (SRV). Characterization of hydraulically induced fracture networks is critical for optimizing stimulation programs and for accurate prediction of production. By including tracers with the fracturing fluid as it is pumped, then measuring the concentrations of the injected tracers during flowback, the effectiveness of the hydraulic fracturing treatment can be quantitatively judged.

More particularly, the present technology allows the proper characterization of hydraulically induced fracture networks using size-engineered colloids as tracers. These provide direct measurements of sizes of the apertures in these networks and thereby provides quantitative assessment of the productivity of individual stages of a hydraulic fracturing treatment.

Current fracture diagnostic techniques are faced with several challenges that might affect their reliability. Firstly, the seismic signals received by sensors are typically very weak and have a low signal/noise ratio, introducing significant uncertainty about the location of the hydraulic fracturing events. Moreover, micro-seismic data are mainly used for imaging fracture distribution and geometric attributes, which is not sufficient for distinguishing open conductive fractures (e.g., those which allow fluid to flow) from nonconductive fractures.

Finally, the pressure transient rate analysis during flow back could only provide the average fracture properties as the production data cannot be allocated to each individual fracture stage. Because fifty or more stages are routinely applied in modern practice, these measurements are not adequate to judge the variability between each stage, which is critical to understanding overall effectiveness. Chemical tracers give valuable insight into stage-to-stage variability and into communication between wells, but they provide no information about the geometry of the fracture networks themselves.

The present technology provides direct indication of these fracture apertures for individual stages of a multistage hydraulic fracturing treatment of a well (e.g., a horizontal well). Moreover, the present technology can provide indication of the apertures of fractures that connect one well to an adjacent well.

It has been found that size of tracers is an important factor which affect the efficiency of the fracture diagnostic. Nanoparticle tracers with sizes larger than matrix pores and smaller than fractures have a lower chance of being trapped in reservoir matrix. The nanoparticle tracers' size and properties could be engineered to distinguish the properties of each individual stages during the flowback. The whole operation does not require a specific completion period, and tracer flowback data can be used to analyze the load recovery of a fracturing fluid, the production contribution of each individual stage and the fracture properties.

Various aspects of the invention will now be described with reference to the figures. For the purposes of illustration, components depicted in the figures are not necessarily drawn to scale. Instead, emphasis is placed on highlighting the various contributions of the components to the functionality of various aspects of the invention. A number of possible alternative features are introduced during the course of this description. It is to be understood that, according to the knowledge and judgment of persons skilled in the art, such alternative features may be substituted in various combinations to arrive at different embodiments of the present invention.

### Fracking

As discussed above, hydraulic fracturing, also called fracking, hydrofracking, and hydrofracturing, is a well stimulation technique involving the fracturing of bedrock formations by a pressurized liquid. The process involves the high-pressure injection of “frac fluid” (usually water, containing sand or other proppants and possibly thickening agents) into a wellbore to create cracks in the deep-rock formations through which natural gas, petroleum, and brine will flow more freely. When the hydraulic pressure is removed from the well, small grains of hydraulic fracturing proppants (either sand or aluminium oxide) hold the fractures open.

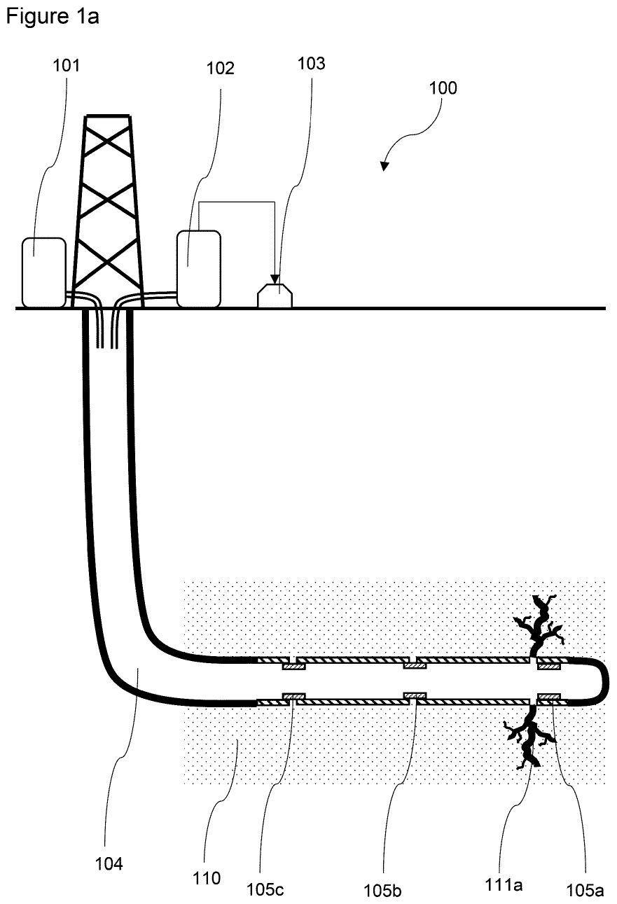

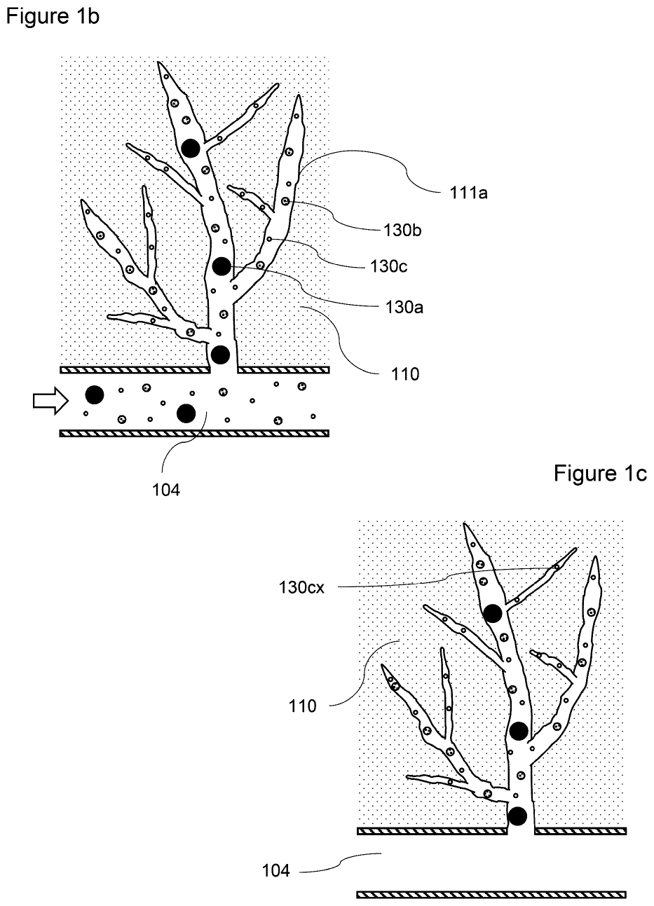

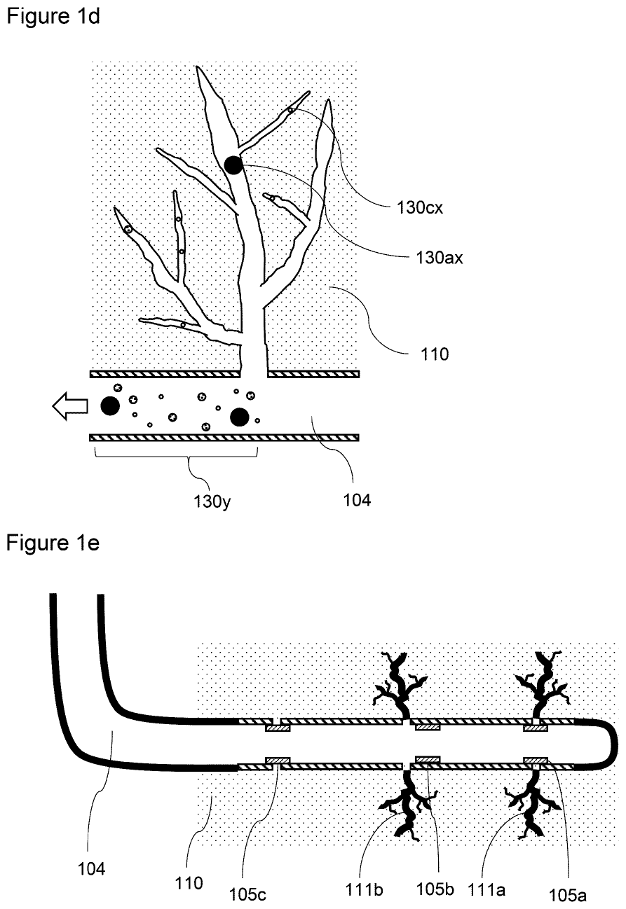

FIG. 1a shows an embodiment of a frack assembly 100 comprising a horizontal well 104, a source of frac fluid 101, a vessel 102 for capturing fluids recovered from the well, and an analyser 103 for analysing the recovered fluid.

The horizontal well 104 in this case comprises a series of three frac stages 105a, b, c. It will be appreciated that wells may have many more frac stages (e.g., up to 10-50 or more). This allows different portions of a formation 110 to be successively fracked. In the situation shown in FIG. 1a, the first stage 105a furthest away from the surface has been fracked to form fractures 111a. A variety of systems may be used to control the opening and closing of each frac stage, including, for example, ball drop, sliding sleeves etc.

Fracking of the first stage is performed by injecting a fluid down hole from the frac fluid source under pressure. In this case, the frac fluid comprises a liquid (e.g., water), proppant (e.g., sand or aluminium oxide), and nanoparticles with a known or predetermined size distribution. In other embodiments, the frac fluid may also comprise a thickening agent or other additives (e.g., acid).

The size and density of the nanoparticles are such that they form a colloid with the liquid components of the frac fluid. That is, the nanoparticles are suspended within the liquid components of the frac fluid which acts as a carrier liquid for the nanoparticles.

It will be appreciated that density differences between the nanoparticles and the carrier liquid may encourage separation if the sedimentation or creaming velocity is greater than the effect of Brownian motion. If the colloidal particles are denser than the medium of suspension, they will sediment (fall to the bottom), or if they are less dense, they will cream (float to the top). Larger particles also have a greater tendency to sediment because the effect of Brownian motion is less.

Separation effects can be avoided if the sedimentation or creaming rate is small relative to the time scale of the fracking. The colloid may be mixed prior to injection to ensure that the nanoparticles are evenly distributed. The source may comprise an agitator to mix the colloid.

Alternatively, or in addition, the colloid may be configured to ensure that the separation rate is relatively slow. The separation rate may be controlled by controlling the densities of the carrier liquid and/or the sized particles and/or controlling the viscosity of the carrier liquid (e.g., by adding a thickening agent). It will be appreciated that some of these changes (e.g., adjusting carrier fluid parameters or picking a particular carrier fluid) may also help ensure that the proppant does not form a sediment within the frac fluid.

The sized particles may be substantially homogeneously dispersed in the carrier fluid. The sized particles may be configured to remain substantially homogeneously dispersed in the carrier fluid for at least 4 weeks (e.g., up to 26 weeks or longer).

FIGS. 1b-1d show a fracture 111a being formed within the formation 110. For clarity, proppant is not shown. It will be appreciated that the fracture is shown to be shorter and wider that would be the case in an actual formation to allow the particles within it to be seen clearly.

FIG. 1b shows the first step in fracturing the formation where a frac fluid is injected from the wellbore 104 into the formation 110 under pressure. In this case, the frac fluid carries sized nanoparticles 130a, b, c with a known size distribution. In this case, there are multiple discrete particle sizes within the particle distribution: large nanoparticles 130a shown in black; medium nanoparticles 130b shown in white; and small nanoparticles 130c shown as dots.

As the pressure is applied a branched fracture is formed. The branched nature of the fracture means that the fracture network is such that there are larger channels towards the wellbore and successively smaller channels as you move away from the wellbore. In this case, there is a large central channel with two medium channels branching off towards the wellbore, and two small channels branching off the central channel at positions further away from the wellbore. The two medium channels also have smaller channels branching off. The channels themselves, in this case, tend to narrow farther away from the wellbore, although the precise structure of the branches and the individual channels will depend on the rock structure (e.g., bulk properties of the rock, pre-existing defects, fault lines, strata).

Pores within the rock matrix allow liquid to move between the rock formation and the fracture network, but, in this case, the nanoparticles stay within the fractured fracture network because their size is larger than the pores. Size-engineered colloids will therefore occupy only a sub-volume of the SRV, the sub-volume corresponding to the total volume of fractures with apertures larger than the colloid diameter (e.g., which is related to the fracture network conductivity).

The frac stage ends when the pumps are shut off. The consequent dissipation of the frac fluid pressure reduces the force holding the fractures open. Thus, the apertures of fractures in the network will gradually become narrower as the pressure dissipates. The largest fractures (e.g., the central branch in this example) contain proppant and thus will stop becoming narrower when the fracture walls can compress the packed proppant grains no further. This is shown in FIG. 1c.

Smaller fractures containing only colloids will likewise become narrower, and some may continue to close until the colloids are squeezed between fracture walls and held tightly in place, possibly embedded into the fracture wall. For example, in FIG. 1c, a small nanoparticle 130cx in the top right small channel has been trapped by the narrowing of that channel. In contrast, small nanoparticles within the large and two medium channels are free and have an open route to the wellbore.

Fractures containing only frac fluid (no proppant, no colloids) may close entirely (not shown in this example), depending on whether shear or slip (relative motion of the fracture walls) occurred during pumping or after pumping ceased. When the pressure is fully dissipated, a fraction of each set of colloids will be distributed in fractures whose apertures are still larger than the colloid diameter. The remainder of each set of colloids will reside in the portion of the fracture network with apertures smaller than the colloid diameter.

FIG. 1d shows the situation where the formation is allowed to produce. This means that fluids from within the formation flows into the fractures where it is directed into the wellbore and up to the surface.

When the well is put on production, sized particles 130y occupying fractures or channels of sufficiently large aperture will flow into the wellbore and be produced at the wellhead. Sized particles which are trapped by the narrowed fractures or channels, either directly by being squeezed by the channel walls in place (e.g., sized particle 130cx) or by indirectly by a narrowing occurring between the sized particle (e.g., sized particle 130ax) and the wellbore, will remain in the formation and not be recovered at surface during production.

Measuring the quantity of produced sized particles over time enables calculation of useful characteristics of the frac stage(s), including efficiency of the frac stage treatment design (volume of the fracture network with apertures exceeding a given size during production, relative to the volume of the fracture network with apertures exceeding that size during pumping), the most likely distribution of aperture sizes in the frac stage during production, and the maximum possible conductivity of the frac stage. As the number of different size-engineered colloids increases, the accuracy of these calculated properties increases.

### Nanoparticles

It will be appreciated that the nanoparticles may be formed from a wide range of materials. In this case, the nanoparticles are formed from barium titanate (BaTiO₃). Barium titanate is a ferroelectric ceramic material.

Using a ceramic material as the nanoparticle material may be useful as they are typically resistant to chemicals which may be found in the formation and/or injected into the well.

Using a ferroelectric material may allow the nanoparticles to be separated from other materials (e.g., proppant particles) using electric an/or magnetic fields.

Other types of nanoparticles that can be used include silica nanoparticles (SiO₂), and iron oxide (Fe₂O₃ or Fe₃O₄) nanoparticles. Theses NPs can be also coated/grafted with surfactants and/or polymers for higher stability.

Different nanoparticles can be distinguished via ICP (Inductively Coupled Plasma) spectroscopy which is used to measure and identify elements within a sample matrix based on the ionization of the elements within the sample. The ICP analysis can provide the type and concentration of elements to ppb (parts per billion) levels.

In the case of using iron oxide nanoparticles, magnetic susceptibility or conductivity measurements can be conducted if the concentration of nanoparticles is within the detection limit of the instrument.

The choice of using different nanoparticles depends on the elements in the formation fluid as well. It may be advantageous to choose a nanoparticle comprising elements which are not present in the formation brine. In this case, ICP analysis can effectively provide the type and concentration of nanoparticles in the produced fluid.

### Multiple Frac Stages

FIG. 1e is a schematic of the horizontal portion of the wellbore 104 during a second frac stage. In this embodiment the well comprises three frac stages 105a-c, each stage being controlled by a sliding sleeve.

As described above, to frac the first stage, the sleeve of the first stage was opened while the sleeve of the second and third stages were kept in a closed position as shown in FIG. 1a. This allowed first volume of frac fluid to be injected selectively into the formation around the first frac stage to create fractures 111a in the formation 110.

As shown in FIG. 1e, to frac the second stage, the sleeve of the first stage is closed, the sleeve of the second stage is opened, and the sleeve of the third stage remains closed. This allows a second volume of frac fluid to be injected selectively into the formation around the second frac stage to create more fractures 111b in the formation 110.

It will be appreciated that the third stage 105c may be fracked by opening that stage while the others are closed.

In general, production from the formation may only be initiated when the fracking of all stages is complete. Switching the well to production typically involves opening or removing all the blockages for all the holes used to frac the formation.

As noted above, analysis of the fractures occurs when the well is put into production, and the mobile sized particles are recovered at the surface. This means that it may be difficult to determine the effectiveness of an individual frac stage because sized particles will be recovered simultaneously from all the frac stages.

To address this issue, each volume of fracking fluid corresponding to each stage may have identifiably different sized particles. This means that when a sized particle is recovered, it would be possible to identify to which frac stage that particle was delivered.

The method may comprise providing each fracking stage with sized particles made from a different material. For example, the first stage could be fracked with a colloid comprising particles of BaTiO₃, while the second could be fracked with a colloid comprising particles of ZnO and so on. At surface, the various types of sized particles can be identified (e.g., using a chemical analysis) or separated using their different physical properties (e.g., using differences in density or in their response to electrical or magnetic stimuli) to be analysed.

### Laboratory Testing

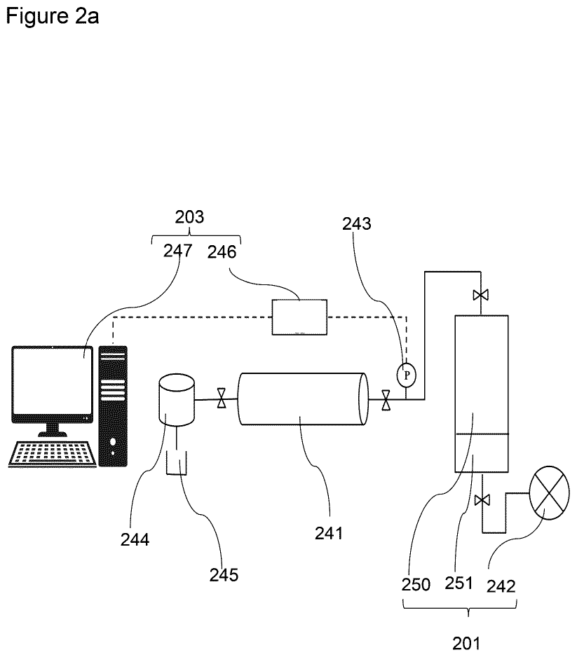

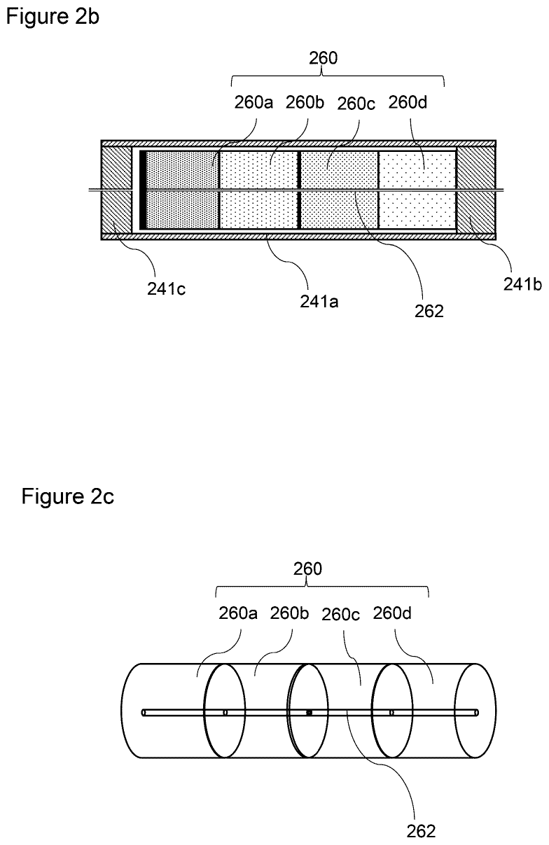

FIG. 2a shows the schematic of the setup for demonstrating the concept of characterizing a frac stage using the sized particle tracer. The schematic consists of a radial core holder 241, a pump 242, a pressure transducer 243, a back pressure regulator (BPR) 244, a transfer vessel 245, and an analyser 203 including a data logger 246 and a processor 247 with processing software. The pump 242 forms part of the colloid source 201. The source 201 comprises a vessel which contains water 250 and a colloid 251 of carrier fluid and sized particles which can be injected into the core contained in the core holder 241.

FIG. 2b is a cross sectional view of the radial core holder 241 as shown in FIG. 2a with a radial core 260 comprising four cylindrical core plugs 260a, b, c, d separated by radial gaps. A perspective view of the core plugs is shown in FIG. 2c. The distance between core plugs acts as hydraulic fractures. This design allows to mimic the real condition of fracture fluid injection and flow back during a multi-stage hydraulic fracturing process. A central channel 262 through the core allows fluid to be injected into core plugs and into the radial inter-plug gaps.

As shown in FIG. 2b, the radial core holder is a vessel for holding a cylindrical core 260 with a cylindrical wall 241a and two end seals 241b,c. The core holder is designed specifically to inject sized particle tracer through the horizontal channel 262 in the middle of the core plugs and allow for the sized particle tracer to be produced radially. Fluid which passes radially through the core can be produced at the outlet of the core holder, through the back pressure regulator 244. The back pressure regulator allows the pressure within the core 262 to be controlled.

For this experiment, nanoparticles with variable sizes ranging from below matrix pore size to above fracture size are used as tracers. To prepare the nanofluid tracer, nanoparticles with different sizes are dispersed in deionized water at a desired concentration. The nanofluid is then injected to the radial system with variable fracture sizes. To vary the matrix pore size, different core plugs with different porosity and permeability are used. Table 1 provides different scenarios to evaluate the effect of NP tracer size on the fracture characterization.

The sized particle tracer injection at each condition is then followed by a soaking period. Afterwards, the tracers are produced at the same injection port. The produced effluents are collected at different time intervals to be analyzed with inductively coupled plasma mass spectrometry (ICP-MS) for tracer concentration. The percent of tracer recovered relative to the amount of tracer injected is then calculated for each case. The obtained results would then shed light on the effect of sized particle tracer size on the flow back production efficiency.

TABLE 1
Different scenarios to evaluate the effect of sized particle
tracer size on induced fracture characterization.

| Scenario | Variables Size | Description |
|---|---|---|
| 1 | NPs tracer < matrix | Tracers invade both matrix and |
| | pore | fracture |
| 2 | matrix pore < NPs | Tracers invade all fractures but not |
| | tracer < fracture | matrix |
| 3 | NPs tracer > some | Tracers invade only some fractures and |
| | fractures | no matrix |

### Field Trial

The inventors have previously synthesized barium titanate (BaTiO₃) sized particles as tracers for a hydraulic fracturing field project in an unconventional reservoir. In this case, the barium titanate particles were nanoparticles. The synthesized sized particle tracer passed the stability and compatibility tests with the fracture fluid. They were subsequently injected into one stage of a horizontal well at a concentration of 0.17 mg/L (mg of nanoparticles per litre of solution). In this case, 170 g nanoparticles were injected with 1000 m³ frac fluid (water). So, it was 170 g BaTiO₃ nanoparticles per 1000 m³ of frac fluid or 170 mg per 1000 litre or 0.17 mg nanoparticles per liter of frac fluid. Neither the fracturing fluid nor the reservoir brine contained measurable concentrations of titanium.

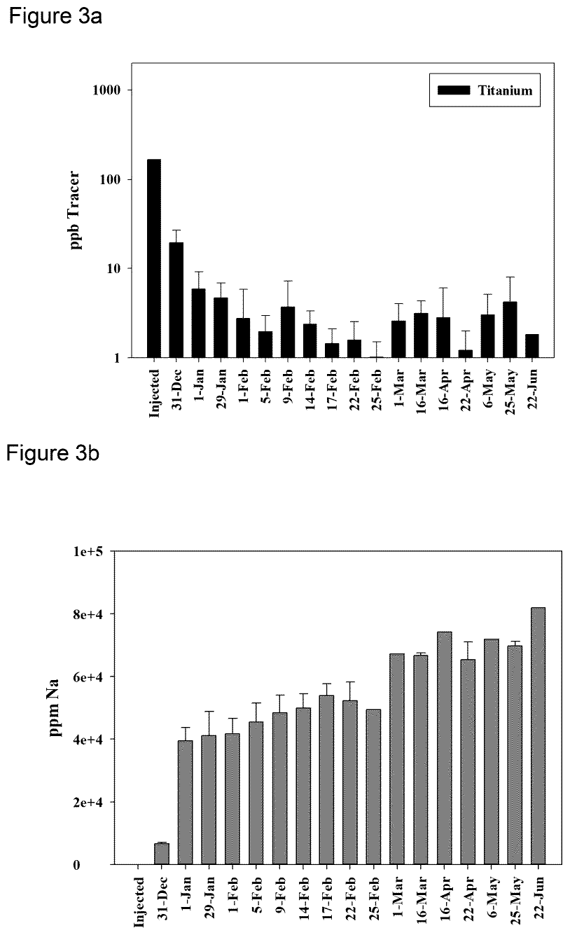

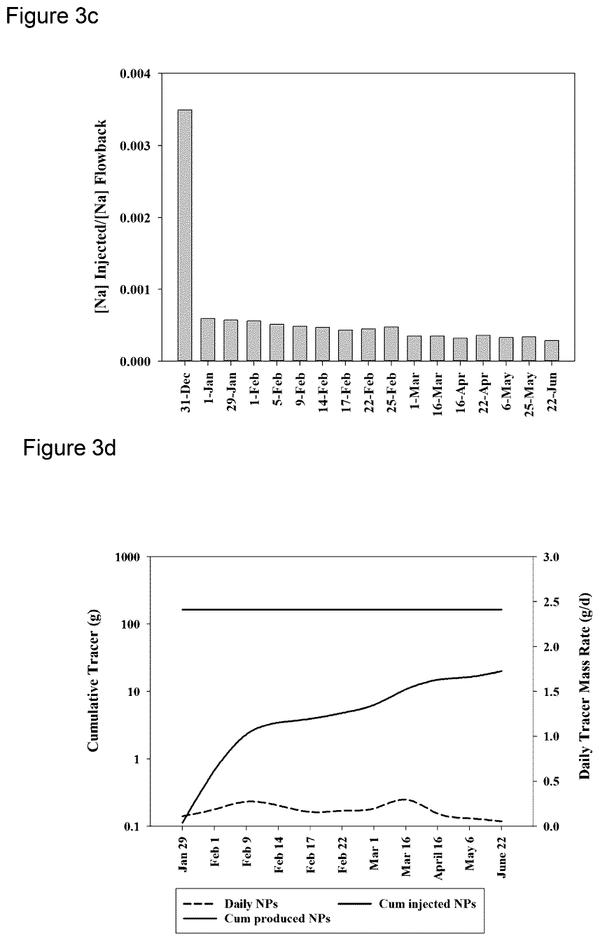

The flowback water samples were collected at different time intervals. The field flow back samples were analyzed using inductively coupled plasma mass spectrometry (ICP-MS) to determine individual ion concentrations. The titanium (Ti) concentration was determined over time as an indication of the presence of barium titanate sized particles tracers. FIG. 3a shows that the concentration of titanium decreased during the flowback and was found to be an indication of sized particle tracers.

In addition to tracer concentration, the concentration of individual ions during flowback was also analyzed. As an example, FIG. 3b shows the concentration of [Na⁺] during flowback and FIG. 3c shows the ratio of injected [Na⁺] over the produced [Na⁺]. Injected [Na+] is the concentration of Na in the fresh frac fluid that was injected to crack the formation. The produced [Na+] is the concentration of Na in the produced water which can be formation brine. As [Na⁺] ion concentration increases over time, it represents an increasing proportion of formation brine in the flowback water. Also, the ratio of [Na⁺] injected/[Na⁺] produced (by number) shows a decreasing trend over time. This suggests mixing of frac fluid with formation brine over time, which is consistent with Ti concentration trend. As there is no source of Titanium in formation brine, mixing of frac fluid with formation brine results in dilution of Ti ion concentration during the flowback.

To calculate the percentage of frac fluid that produced compared to that of the formation brine, the salinity ion concentration of the flowback water sample was analyzed using CI⁻ and Br to construct a mixing model. The significance of CI⁻ Br was the fact that they are considered conservative, i.e., that they do not typically involve in water/mineral reactions. The final sample collected after 6 months of flowback (June 22) was considered as an approximation for the formation brine concentration as the salinity curve reached almost plateau by then. The linear mixing approach was then conducted on the flowback water concentrations to determine the percentage of frac fluid production over time. The mixing model analysis determined that about 98-99% of the produced water collected after 5 months of production (May 25) was formation brine and 1-2% was the injected frac fluid.

The mass balance calculation was also conducted to find the daily rate of produced tracers as well as the injected and cumulative produced tracers over time.

FIG. 3d is a graph of the injected and produced mass of sized particles tracer (NPs) during flowback from the field trial. The injected sized particle tracer was injected at the start of the experiment and is shown as a horizontal line towards the top of the graph. The cumulative produced or extracted sized particles (NPs) is the monotonically increasing solid line in the middle of the graph. The two solid lines are associated with the left-hand y-axis (note the logarithmic scale). The dashed line at the bottom is the daily rate of sized particles tracer production and is associated with the right-hand y-axis (linear scale).

FIG. 3d compares the injected and produced mass of sized particles (NPs). About 10% of sized particles are produced during flow back. As discussed above, analysis of the salinity during flowback indicates that only 1 to 2% of the total frac fluid returned.

The higher recovery of sized particles (10%) compared to salinity during the flowback (1-2%) is related to the different size of sized particles compared to salt molecules. Nanoparticle tracers were a few hundred nm whereas salts were in molecule size. Thus, the part of the flow system that accommodates a few hundred nm particles is not the same as the flow system that accommodates molecules. More specifically, during pumping the salinity ions are transported with the frac fluid into the entire volume of the induced fracture network and the adjacent rock matrix, whereas the nanoparticles are transported only into the volume of the induced fracture network with apertures greater than the nanoparticle diameter.

Because about 10% of sized particles are produced during flow back, it can be determined that about 10% of the productive fracture network has apertures wider than the sized particles. The volume of the remaining fractures (90%) of this productive fracture network must have apertures narrower than the sized particles. Knowing the size of the sized particles, we can then estimate the fluid conductivity of the productive portion of the fracture network.

By repeating similar analysis of tracers added to other stages, the operator gains valuable insight into effectiveness of the stimulation program. Key metrics derived from this analysis include: the effective stimulated rock volume, and the effective conductivity of each stage, all relative to the volume of frac fluid used.

### Method

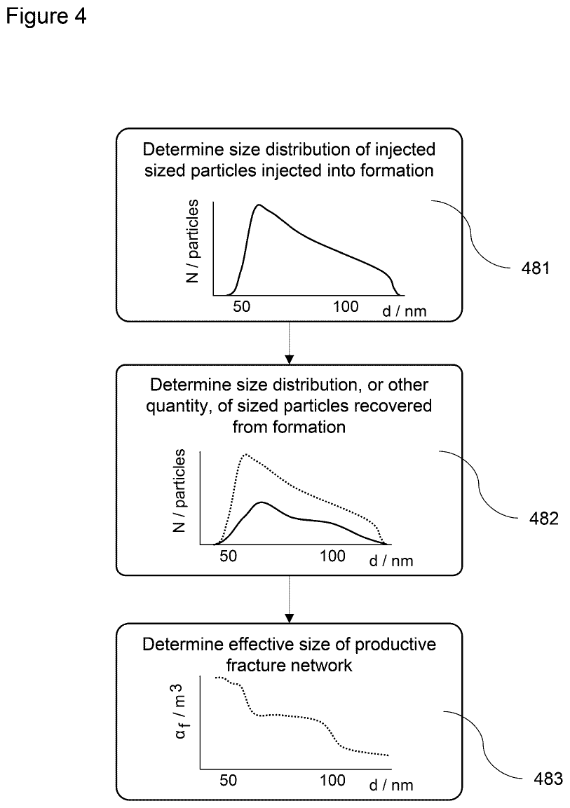

As shown in FIG. 4, the method includes a number of steps. First, the method comprises determining 481 the size distribution of injected sized particles injected into formation. As shown on the schematic graph, this may relate to the number of particles injected into the formation. The size distribution may also include information on the volume of colloid injected into the formation.

After the fracture network has been injected with the colloid, the formation is allowed to produce, and the quantity of recovered sized particles is determined 482. The liquid recovered from the well may include fluid initially injected into the well, aqueous formation fluids (e.g., brine) and/or hydrocarbon formation fluids.

The determined quantity of the recovered sized particles may be a size distribution, as shown in FIG. 4. In other embodiment, the determined quantity may be the amount of sized particle material recovered. E.g., where the particles injected are BaTiO₃, determining the amount of titanium recovered would allow a ratio between the amount (e.g., mass, or number) of particles injected and particles recovered to be determined.

Then, the method comprises determining 483 the effective size distribution of the productive fracture network which is determined based on the size distribution of the injected sized particles and the measured quantity of extracted sized particles. In this case, the effective size distribution, α_{f}, of the fracture network is expressed, in this example, as a graph of the connected volume of a fracture network which is directly connected to the wellbore via channels of greater than a particular lateral dimension, d.

In other embodiments, the effective size of the productive fracture network may correspond to the volume of the fractures from which the injected sized particles returned. This may be calculated based on the ratio between the amount of particles injected and particles recovered.

### Options

The process may involve varying the fracture size and to speed up evaluating different conditions, micromodels can be used. The micro models can be designed with different matrix and fracture sizes and different network complexity to evaluate their effect on NPs tracer flowback efficiency.

The process may use nano emulsions tracers in addition to NPs tracer. The nano emulsion tracer size could be also engineered for the above tests. Nano emulsions may be oil in water emulsions with nm size which are also stabilized by nanoparticles.

The present technology could be employed in other sectors of the oil and gas industry, especially in enhanced oil recovery processes. Chemical tracer tests have been widely used for IOR/EOR projects in conventional reservoirs by injecting identifiable chemical compounds into the formation and monitoring their production data. The NPs tracers with variable sizes could be also used as tracers for EOR processes to characterize conventional reservoirs.

The present technology may also be used in other downhole technologies, such as open loop geothermal systems and/or carbon capture and storage applications.

Although the present invention has been described and illustrated with respect to preferred embodiments and preferred uses thereof, it is not to be so limited since modifications and changes can be made therein which are within the full, intended scope of the invention as understood by those skilled in the art.

### BIBLIOGRAPHY

The following documents are cited for reference:
Elahi, S. H.; Jafarpour, B., Dynamic fracture characterization from tracer-test and flow-rate data with ensemble Kalman filter. SPE Journal 2018, 23 (02), 449-466.
Wright, C.; Davis, E.; Weijers, L.; Minner, W.; Hennigan, C.; Golich, G. In Horizontal hydraulic fractures: Oddball occurrences or practical engineering concern?, SPE Western Regional Meeting, OnePetro: 1997.
Wright, C.; Minner, W.; Weijers, L.; Davis, E.; Golich, G.; Kikuchi, H. In Wellbore-to-fracture communication problems pose challenges in California diatomite horizontal wells, SPE Annual Technical Conference and Exhibition, Society of Petroleum Engineers: 1997.
Wright, C.; Weijers, L.; Davis, E.; Mayerhofer, M. In Understanding hydraulic fracture growth: Tricky but not hopeless, SPE annual technical conference and exhibition, Society of Petroleum Engineers: 1999.
Cipolla, C.; Wright, C. In State-of-the-art in hydraulic fracture diagnostics, SPE Asia Pacific Oil and Gas Conference and Exhibition, OnePetro: 2000.
King, G. E. In Thirty years of gas shale fracturing: what have we learned?, SPE annual technical conference and exhibition, OnePetro: 2010.
Cipolla, C. L.; Williams, M. J.; Weng, X.; Mack, M.; Maxwell, S. In Hydraulic fracture monitoring to reservoir simulation: maximizing value, Second EAGE middle east tight gas reservoirs workshop, European Association of Geoscientists & Engineers: 2010; pp cp-244-00015.
Ghods, P.; Zhang, D. In Automatic estimation of fracture properties in multi-stage fractured shale gas horizontal wells for reservoir modeling, SPE western regional meeting, OnePetro: 2012.
Moreno, J.; Tarrahi, M.; Gildin, E.; Gonzales, S. In Real-Time Estimation of Hydraulic Fracture Characteristics from Production Data, SPE/AAPG/SEG Unconventional Resources Technology Conference, OnePetro: 2014.
Elahi, S. H.; Jafarpour, B. In Characterization of fracture length and conductivity from tracer test and production data with Ensemble Kalman filter, Unconventional Resources Technology Conference, San Antonio, Texas, 20-22 Jul. 2015, Society of Exploration Geophysicists, American Association of Petroleum . . . :2015; pp 1192-1200.
Peyret, O.; Drew, J.; Mack, M.; Brook, K.; Maxwell, S.; Cipolla, C. In Subsurface to surface microseismic monitoring for hydraulic fracturing, SPE Annual Technical Conference and Exhibition, OnePetro: 2012.
Li, L.; Jiang, H.; Li, J.; Wu, K.; Meng, F.; Chen, Z., Modeling tracer flowback in tight oil reservoirs with complex fracture networks. Journal of Petroleum Science and Engineering 2017, 157, 1007-1020.
Clarkson, C.; Williams-Kovacs, J. In A new method for modeling multi-phase flowback of multi-fractured horizontal tight oil wells to determine hydraulic fracture properties, SPE Annual Technical Conference and Exhibition, OnePetro: 2013.
Zemel, B., Tracers in the oil field. Elsevier: 1995.
Tian, W.; Darnley, A.; Mohle, T.; Johns, K.; Dempsey, C. In Understanding frac fluid distribution of an individual frac stage from chemical tracer flowback data, SPE Hydraulic Fracturing Technology Conference and Exhibition, OnePetro: 2019.
Tian, W. In Improved Method of Moments to Determine Mobile Phase Saturations with Single Well Chemical Tracer Test, SPE Annual Technical Conference and Exhibition, OnePetro: 2017.
Salman, A.; Kurtoglu, B.; Kazemi, H. In Analysis of chemical tracer flowback in unconventional reservoirs, SPE/CSUR Unconventional Resources Conference-Canada, OnePetro: 2014.

1. A method for determining an effective size of a productive fracture network within an underground formation, the method comprising:
injecting a colloid into the formation, the colloid comprising a carrier liquid and sized particles with a particular size distribution;
extracting a fluid from the formation, the fluid comprising a portion of the injected sized particles;
measuring a quantity of the extracted sized particles; and
determining the effective size of the productive fracture network based on the size distribution of the injected sized particles and the measured quantity of extracted sized particles.

2. The method according to claim 1, wherein the method comprises generating the fracture network by fracking.

3. The method according to claim 2, wherein the fracking comprises injecting a frac fluid into the formation via a wellbore.

4. The method according to claim 3, wherein the frac fluid comprises a proppant.

5. The method according to claim 3, wherein the colloid comprises the frac fluid.

6. The method according to claim 2, wherein the fracking comprises multiple frac stages, each frac stage corresponding to a volume of the frac fluid being injected into a different spatial region of the formation, wherein the sized particles in each frac volume associated with each stage are identifiably different.

7. The method according to claim 6, wherein the sized particles are formed from a different material for each frac stage.

8. The method according to claim 1, wherein measuring the quantity of the extracted sized particles comprises determining a size distribution of the extracted sized particles.

9. The method according to claim 1, wherein measuring the quantity of the extracted sized particles comprises determining an amount of material making up the extracted sized particles.

10. The method according to claim 1, wherein the sized particles have maximum dimension of between 10 nm and 1 micron.

11. The method according to claim 1, wherein the sized particles are insoluble in water and insoluble in hydrocarbons.

12. The method according to claim 1, wherein a quantity of the extracted sized particles is measured using a combination of one or more of: Dynamic Light Scattering and Inductively Coupled Plasma analysis.

13. The method according to claim 1, wherein the sized particles comprise one or more of: barium titanate, iron oxide, Fe₂O₃, Fe₃O₄, SiO₂, TiO₂, silica, and zinc oxide.

14. The method according to claim 1, wherein the method comprises measuring a quantity of the extracted fluid.

15. The method according to claim 14, wherein the method comprises determining the quantity of a particular ion or salt in the extracted fluid.

16. The method according to claim 13, wherein the method comprises determining a quantity of formation fluid produced from the formation.

17. The method according to claim 14, wherein the method comprises determining a quantity of carrier liquid recovered from the formation during the extraction of the fluid from the formation.

18. The method according to claim 17, wherein the method comprises determining a measure of the size of the fracture network based the measured quantity of the recovered carrier liquid.

19. An apparatus for determining a measure of the size of a productive fracture network, the apparatus comprising:
a wellbore positioned within a formation;
a colloid source, the colloid comprising a carrier liquid and sized particles of a known size distribution;
a pump for injecting the colloid into the formation via the wellbore;
a container for containing fluids extracted from the wellbore;
an analyser for measuring a quantity of the extracted sized particles; and
a controller for determining the measure of the size of the productive fracture network based on the size distribution of the injected sized particles and the measured quantity of extracted sized particles.

20. Use of nanoparticles with a predetermined size distribution in determining a measure of the size of a productive fracture network.
